(19) United States
(12) Patent Application Publication
(10) Pub. No.: US 2023/0211301 A1
(43) Pub. Date: Jul. 6, 2023

(54) MOBILE SYSTEMS FOR MIXING AND DISPENSING

(71) Applicant: Thomas P. Gray, II, Reynoldsburg, OH (US)

(72) Inventor: Thomas P. Gray, II, Reynoldsburg, OH (US)

(21) Appl. No.: 18/092,735

(22) Filed: Jan. 3, 2023

Related U.S. Application Data
(60) Provisional application No. 63/295,766, filed on Dec. 31, 2021.

(51) Int. Cl. B01F 33/502; B01F 35/71

(52) U.S. Cl. CPC B01F 33/5021; B01F 35/7176

(57) ABSTRACT

Mobile systems for mixing and dispensing. The systems include a vehicle, a dispenser, a means for transferring a primary fluid to the dispenser from a primary fluid source, and one or more vessels of a secondary fluid that are fluidly connected to the dispenser. The dispenser includes an assembly of fluid distribution components that define a fluid channel that enables the primary fluid to flow through the dispenser. Incorporated into the fluid channel is an aspirator component that enables the dispenser to aspirate a secondary fluid into the fluid channel when the primary fluid is flowing through it, thereby yielding an operative fluid. Disclosed are embodiments of the system where the means for transferring a primary fluid is either a stand-alone pump or a truck mount. Also disclosed are embodiments of the system where the primary fluid source is a portable vessel located within the interior of the vehicle.

### CROSS-REFERENCE TO RELATED APPLICATIONS

This application is a nonprovisional patent application that makes a priority claim to U.S. Application No. 63/295,766.

### FIELD

The application relates to systems for mixing and dispensing and, more particularly, to mobile systems for mixing and dispensing that can be used in a remote location (i.e., at a job site or in the field).

### BACKGROUND

Due to companies requiring versatility to service their customers, more and more products/chemicals have to be utilized due to the increased demands brought on by the customer. Customers want a one-stop shop for products being purchased and services being rendered. This leaves companies with the decision to either store manufacturer concentrated chemicals on their service vehicles and rely on their employees in the field to mix those ready to use solutions, or premix manufacturer concentrated chemicals in-house and put those newly mixed and ready-to-sue solutions in their service vehicles.

There are problems involved with putting concentrated chemicals, not yet ready to use, on vehicles. For one, the company would have to rely on employees to properly and safely mix/dilute concentrated chemicals into a ready-to-use solution, which amounts to an additional task and training obstacle for an employer and employee. This may not be the employee's field of expertise. There are also safety issues associated with the handling of concentrated chemicals, such as skin sensitivities, the risk of breathing in vapors which can cause respiratory problems, and a splash risk of getting the chemicals in the employee's eyes, among other things. Further, there are liability issues for the employer, general OSHA considerations (which can result in issues, problems, and fines). There can also be an increased likelihood of improper mixing, resulting in solutions that are ineffective or too strong, or otherwise not well suited for its intended purpose. Proper mixing is of the upmost importance, especially when such chemicals/solutions are to be used in a professional capacity. Containers can get mixed up and may not have proper labeling, which can cause improper use due to a lack of directions, a risk to employee safety in handing the product, vehicle accidents, and the absence of the proper MSDS sheet for a particular container for medical attention or the fire department or for spill containment. There are also problems involved with premixing manufacturer concentrated chemicals into ready-to-use solutions and putting them on service vehicles. For one, service vehicles may be limited in cargo capacity. Further, there is often a multitude of different chemicals that are needed throughout the course of a given day. So given that the containers for these sorts of chemicals typically come in 1 gallon, 5 gallon, 55 gallon sizes, or in actual totes up to 300 gallons in size, there simply may not be enough cargo space in a service vehicle to hold all of them. Additionally, transporting ready-to-use solutions can add a lot of weight to a service vehicle. This extra weight can heighten safety issues and result in a greater possibility of vehicular accident.

This extra weight can also cause additional wear and tear on vehicle engines, transmission systems, and braking systems.

The amount and types of chemicals used today is growing rapidly, resulting in an endless number of choices for a company to choose from. For example, companies in the professional mobile carpet cleaning industry commonly use pre-sprays for general soiling, pre-sprays for general degreasing of hard surface flooring, pre-sprays for severe soiling, pre-sprays for severe degreasing of hard surface flooring, deodorizers, disinfectants, routine detergents for stain release carpeting (having the proper pH), routine commercial detergents, and carpet and upholstery protectors. Companies in the professional power washing industry commonly use chemicals for: washing vehicles (e.g., cars, trucks, vans, boats ATVs, RVs, etc.); washing houses (e.g., siding, decks, and windows); cleaning cement/concrete; masonry restoration; degreasing kitchens, hoods, cooking areas, manufacturing equipment, and industrial machines; cleaning hoods, ducts, and drains; removing graffiti; stripping paint and coat clearing; and removing mildew. Companies in the professional car detailing industry commonly use, for example, soaps for a multitude of surfaces, paint cleaners, degreasers, dressings for vehicle engine bays and the undercarriages of cars, and dressings for tires. Companies in the professional lawn service industry commonly use a multitude of chemicals as well.

### SUMMARY OF THE INVENTION

Disclosed are mobile systems for mixing and dispensing.

In one embodiment, the system includes: a vehicle with an interior; a first vessel for containing a quantity of a first liquid, wherein the first vessel is located within the interior of the vehicle; a second vessel for containing a quantity of a second liquid, wherein the second vessel is located within the interior of the vehicle; a dispenser for dispensing quantities of the first liquid and the second liquid; and a pump fluidly connected to the first vessel and the dispenser, wherein the pump is configured to transfer the first liquid from the first vessel to the dispenser, and wherein the pump is located within the interior of the vehicle. The dispenser is located within the interior of the vehicle. The dispenser includes a first intake port, a second intake port, and a fluid outlet port. The first intake port is fluidly connected to the first vessel and the second intake port is fluidly connected to the second vessel. The dispenser further includes a fluid channel that enables the first liquid to flow from the first intake port to the fluid outlet port. The dispenser further includes an aspirator component incorporated into the fluid channel that is fluidly connected to the second intake port. The aspirator component enables aspiration of the second liquid into the fluid channel when the first liquid is flowing through the fluid channel, thereby yielding an operative fluid in the fluid channel.

In another embodiment, the system includes: a vehicle with an interior; a water tank for containing a quantity of water, wherein the water tank is located within the interior of the vehicle; a container for containing a quantity of chemical solution, wherein the container is located within the interior of the vehicle; a dispenser for dispensing an operative fluid; and a heat extraction truck mount unit located within the interior of the vehicle. The dispenser is located within the interior of the vehicle. The dispenser includes a first manifold, a second manifold, and a fluid channel fluidly connecting the first and second manifolds. The first manifold includes a water intake port. The second manifold includes an operative fluid outlet port. The dispenser further includes an aspirator component incorporated into the fluid channel that is fluidly connected to the container. The aspirator component is configured to aspirate concentrated chemical solution into the fluid channel when water is flowing through the fluid channel, thereby yielding an operative fluid in the fluid channel. The heat extraction truck mount unit includes: a water intake port fluidly connected to the water tank; a fluid outlet port; a fluid channel that enables the water to flow from the water intake port to the fluid outlet; a pump for transferring the water from the water intake port to the fluid outlet; and a heating element for heating the water as it is transferred from the water intake port to the fluid outlet port.

In yet another embodiment, the mobile system for mixing and dispensing includes: a vehicle with an interior; a container of liquid chemical solution located within the interior of the vehicle; a dispenser for dispensing quantities of a first liquid and a second liquid; and a pump fluidly connected to the first vessel and the dispenser, wherein the pump is configured to transfer water from the water source to the dispenser, and wherein the pump is located within the interior of the vehicle. The dispenser is located within the interior of the vehicle. The dispenser includes a first intake port, a second intake port, and a fluid outlet port. The first intake port is fluidly connectable to a water source. The second intake port is fluidly connected to the container of chemical solution. The dispenser further includes a fluid channel that enables water to flow from the first intake port to the fluid outlet port. The dispenser further includes an aspirator component incorporated into the fluid channel that is fluidly connected to the second intake port. The aspirator component enables aspiration of the second liquid into the fluid channel when the first liquid is flowing through the fluid channel, thereby yielding an operative fluid in the fluid channel.

Other examples of the disclosed mobile systems for mixing and dispensing will become apparent from the following detailed description, the accompanying drawings and the appended claims.

### BRIEF DESCRIPTION OF THE DRAWINGS

FIG. 1 is a schematic illustration of a first embodiment of the system for mobile mixing and dispensing;

FIG. 2 is a schematic illustration of a second embodiment of the system for mobile mixing and dispensing;

FIG. 3 is a schematic illustration of a third embodiment of the system for mobile mixing and dispensing;

FIG. 4 is a schematic illustration of a fourth embodiment of the system for mobile mixing and dispensing;

FIG. 5 is a front view of an exemplary dispenser that may be utilized with the system for mobile mixing and dispensing;

FIG. 6 is a top perspective view of a receiving container that may be utilized with the system for mobile mixing and dispensing;

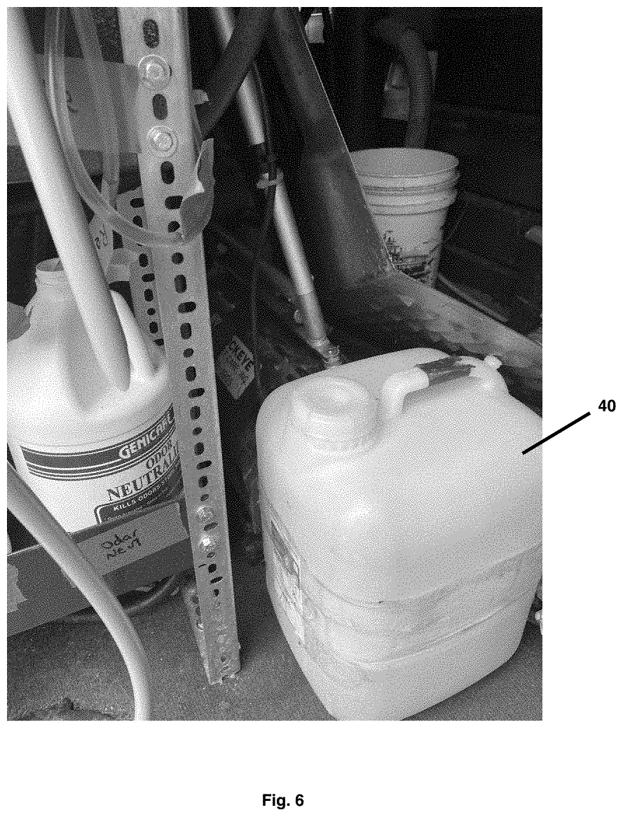

FIG. 7 is a schematic illustration of another exemplary dispenser that may be utilized with the system for mobile mixing and dispensing;

FIG. 8 is a front view of a pump and water tank that may be utilized with the system for mobile mixing and dispensing;

FIG. 9 is a front view of a truck mount that may be utilized with the system for mobile mixing and dispensing;

FIG. 10 is a front view of the truck mount of FIG. 9;

FIG. 11 is a side perspective view of the truck mount of FIG. 9;

FIG. 12 is a front view of an end-tool that may be utilized with the system for mobile mixing and dispensing; and

FIG. 13 is a top perspective view of a waste container that may be utilized with the system for mobile mixing and dispensing.

### DETAILED DESCRIPTION

The following detailed description refers to the accompanying drawings, which illustrate specific examples described by the disclosure. Other examples having different structures and operations do not depart from the scope of the present disclosure. Like reference numerals may refer to the same feature, element, or component in the different drawings.

Illustrative, non-exhaustive examples, which may be, but are not necessarily, claimed, of the subject matter according the present disclosure are provided below. Reference herein to “example” means that one or more feature, structure, element, component, characteristic and/or operational step described in connection with the example is included in at least one embodiment and/or implementation of the subject matter according to the present disclosure. Thus, the phrase “an example” and similar language throughout the present disclosure may, but do not necessarily, refer to the same example. Further, the subject matter characterizing any one example may, but does not necessarily, include the subject matter characterizing any other example.

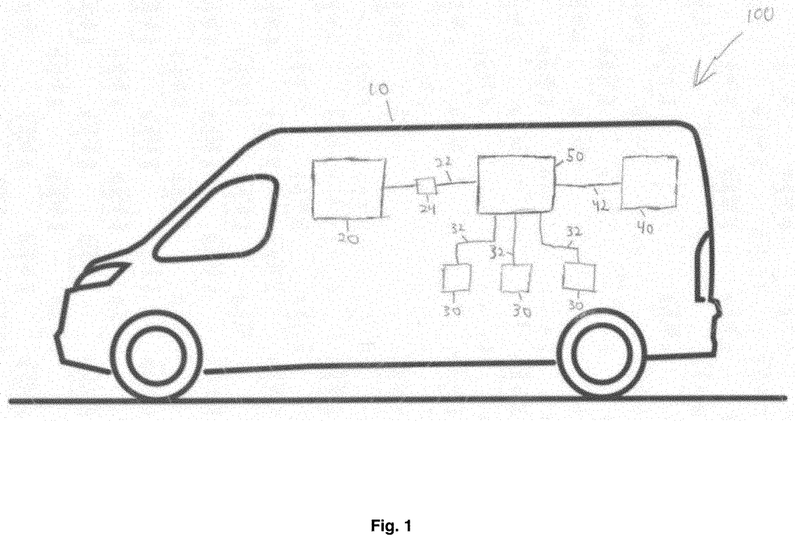

Referring to FIG. 1, the present disclosure provides a first exemplary embodiment of a system for mobile mixing and dispensing 100 (herein, the “system”). The system 100 is configured to provide mobile liquid chemical mixing capabilities so that a mixed solution (herein, the “operative fluid”) can be obtained even in remote locations (e.g., at a job site or in the field). It is contemplated that such mixing capabilities may be desirable for service industries that require the use of liquid chemicals that need to be mixed or diluted before they are suitable for use. These industries can include, for example, mobile carpet cleaning services, mobile power washing services, mobile car detailing services, mobile lawn services, and/or any other service or industry that could benefit from mobile mixing capabilities.

The system 100 described herein is not limited in its applicability to any particular type of chemical. For example, it is contemplated that the system 100 can be utilized with chemical protectors, disinfectants, deodorizers, and fertilizers, among other things. It is also contemplated that the system can be utilized with chemicals for specific purposes such as, for example, carpet cleaning chemicals, lawn service chemicals, stain removing chemicals, and vehicle cleaning chemicals for spray cleaning highway dirt and grime off highway vehicles. It is further contemplated that the system 100 can also be used to dilute concentrated chemical solutions.

The system 100 includes a vehicle 10 that defines or otherwise has an open interior. The vehicle 10 houses and transports the other components of the system 100. The vehicle 10 is not limited to any particular type of vehicle so long as a sufficient amount of space is provided for all of the necessary system components. It is contemplated that the vehicle 10 may include, for example, a utility van, truck, hitch trailer, and/or the like.

If required, any suitable attachment/mounting means may be utilized to secure/house/mount/install the various components of the system 100 to the vehicle 10 (e.g., mechanical fasteners, welds, adhesives, etc.).

The system 100 includes a dispenser 50 that is configured to intake fluids from one or more sources and dispense them in measured, predetermined quantities. It is contemplated that through use of the dispenser 50, it can be ensured that the resulting solution (i.e., the “operative fluid”) is a precise formulation of the chemicals and/or water that was mixed.

The dispenser 50 includes one or more intake ports that can be coupled to hoses 32, 22 (e.g., fluid lines) which, in turn, can be fluidly connected to various fluid sources. Hose 22 can be fluidly connected to a primary fluid source 20. Hoses 32 can be fluidly connected to one or more secondary fluid sources 30 (three being shown). The primary and secondary fluid sources 20, 30 each be, independently of one another, either a chemical solution source or a water source. These sources may be portable vessels capable of being transported within the vehicle 10. For example, primary fluid source 20 may be a water tank with a holding capacity of about 50 gallons to about 120 gallons, or more preferably about 100 gallons. In this case, water would be the primary fluid. A secondary fluid source 30 may be a 1-gallon portable container of chemical solution, with the chemical solution being the secondary fluid. These intake ports are not limited to any particular type of fitting or design, and may be adapted or selected based on the type of hoses available and/or the type of chemicals to be introduced.

The dispenser 50 includes an assembly of fluid distribution components that includes or defines one or more fluid channels for the flow of chemicals and/or water through the dispenser 50 from the intake ports. Here, any suitable configuration fluid distribution components may be incorporated to facilitate the establishing and control of said flow (e.g., pipes, tubes, fittings, joints, valves, pumps, impellers, etc.). Further, the dispenser 50 may also incorporate electronic circuitry components (e.g., processors, memory, power supply, wireless communication modules, etc.) and user interface components (e.g., push buttons, knobs, touchscreen displays, etc.) to improve the functionality of the dispenser 50, such as to automate certain functions.

The dispenser 50 also includes or defines one or more outlet ports that enables the dispenser 50 to dispense chemicals and/or water from a fluid channel. The outlet ports enable hoses 42 to be connected to the dispenser 50 which, in turn, may be inserted into a receiving container 40 wherein the fluids may be collected for later use or, alternatively, connected to another system component for immediate use (e.g., a truck mount or vacuum wand). The outlet ports are not limited to any particular type of fitting or design, and may be adapted or selected based on the type of hoses available and/or the type of chemicals and/or water to be dispensed.

The system 100 may include a receiving container 40 for receiving fluids (e.g., chemicals and/or water) from the dispenser 50. If the fluids have not been mixed already, the receiving container 40 may serve as the vessel where mixing takes place. The receiving container 40 is not limited to any particular type of container, but some examples that can be suitable here includes, but is not limited to, 5-gallon buckets, 55-gallon buckets, hand sprayers, pump sprayers, and the like. From here, the operative fluid can be utilized as needed.

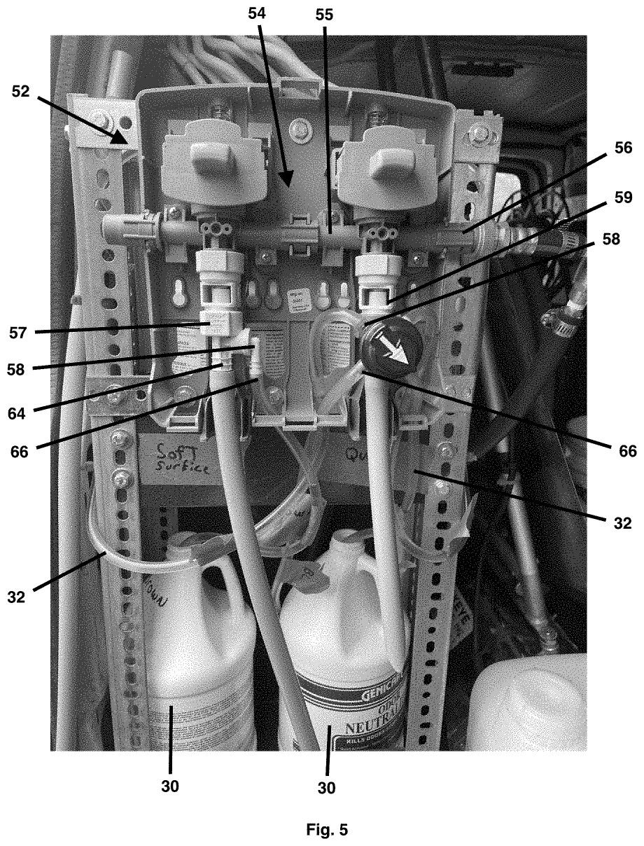

Referring to FIG. 5, the present disclosure provides an exemplary embodiment of a dispenser 52. This dispenser 52 includes an assembly of fluid distribution components 54, a primary intake port 56, a plurality of secondary intake ports 58, and outlet ports 64. The primary intake port 56 and the secondary intake ports 58 can each be fluidly connected to a primary or secondary fluid source (e.g., portable vessels located within the interior of the vehicle 10 or non-portable sources located on a job site). The assembly of fluid distribution components 54 includes manifold 55 that is configured to direct a primary fluid coming into the dispenser 52 through the primary intake port 56 to aspirator components 57 and 59. Here, both the secondary intake ports 58 and the outlet ports 64 are incorporated into, or formed along with, the aspirator components 57 and 59. The aspirator components 57, 59 and the manifold 55 collectively define fluid channels that enable the flow of primary fluid from the primary intake port 56 to the outlet ports 64 (where they may be dispensed out of the dispenser 52). In practice, the aspirator components 57, 59 are configured to aspirate (i.e., to withdraw fluid by negative pressure or suction) secondary fluids from the secondary intake ports 58 into the fluid channels when the primary fluid is flowing through them. This causes the primary fluid and the secondary fluids to mix in the fluid channels thereby yielding an operative fluid. Here, aspirator component 57 includes a tee joint with a hose barb that serves as a secondary intake port 58; and aspirator component 59 includes a 4-way cross fitting with hose fittings that serve as second intake ports 58. Notably, aspirator component 59 also includes a control knob that enables a user to choose which secondary intake port 58 to aspirate from.

As used herein, the term “primary fluid” refers to the fluid that flows through a dispenser and causes the aspiration of a “secondary fluid” (i.e., a working fluid or a venturi). The “secondary fluid” is the fluid that gets aspirated.

Those skilled in the art will appreciate that the dispenser design described above is not meant to be limiting. Other embodiments of the dispenser may feature different aspirator component/secondary intake port/outlet port configurations.

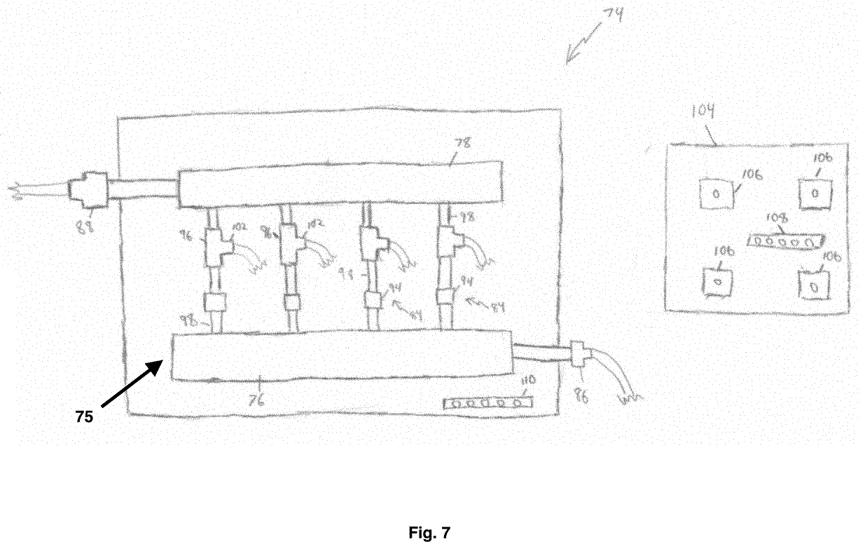

Referring to FIG. 7, the present disclosure provides another exemplary embodiment of a dispenser 74. The dispenser 74 includes an assembly of fluid distribution components 75 that includes a first manifold 76, an opposing second manifold 78, and one or more connecting channels 84 between the two manifolds 76, 78 that provide for the flow of fluid between them (four being shown). The first manifold 76 includes a primary intake port 86 that can be connected to a hose and utilized to direct a primary fluid into the interior of the first manifold 76. The first manifold 76 then directs the primary fluid through one or more of the connecting channels 84. The connecting channels 84 may each include any suitable arrangement or configuration of fluid distribution components (e.g., pipe, tubing, fittings, etc.) capable of directing the primary fluid to the second manifold 78. The second manifold 78, like the first manifold 76, also defines an interior. Moreover, the second manifold 78 includes an outlet port 88. Fluid from the connecting channels 84 may collect within the interior of the second manifold 78 before then flowing out of the dispenser 74 through outlet port 88. Thus, the first manifold 76, second manifold 78, and the connecting channels 84 collectively define fluid channels that enable the flow of a primary fluid from the primary intake port 86 to the outlet port 88.

Dispenser 74 further includes valves 94 and aspirator components 96 incorporated into each of the connecting channels 84. The valves 94 are provided to open or close the connecting channels 84, thereby stopping or starting a flow of primary fluid through them. The aspirator components 96 are provided to enable secondary fluid aspiration from the secondary intake ports 102 into the connecting channels 84 when the primary fluid is flowing through them. This causes the primary fluid and the secondary fluids to mix in the connecting channels 84 and/or the second manifold 78, thereby yielding an operative fluid. A user may choose which connecting channels 84 to open or close (either individually or in combination) to yield different operative fluid formulations.

Preferably, the valves 94 of the FIG. 7 dispenser may be opened or closed via electronically activated actuation. For example, valves 94 may be solenoid valves (e.g., 12-volt solenoid valves) that are each operatively connected to a control switch 106 provided on a control panel 104 (which may be attached directly to the dispenser or provided as a separate component). The operative connection between the valves 94 and the control switches 106 may be provided by any suitable means, including by wired connection or wireless connection. Power may be supplied to the valves 94 and the control panel 104 from a power source, which may be the battery of the mobile vehicle or a separate dedicated battery. Any other necessary electronic circuitry (e.g., processors, memory, wireless communications modules, etc.; and positive block 108 and ground block 110 for wired embodiments) may also be provided to enable the functions of the dispenser described herein.

The various components of dispenser 74 (e.g., the first manifold 76, second manifold 78, connecting channels 84, aspirator components 96, and valves 94) may be fabricated from a variety of materials and dimensions (e.g., nominal wall thickness). Preferred material compositions include brass and stainless steel. Preferred dimensions include a nominal wall thickness of at least 1.8 millimeters. For example, the first manifold 76, second manifold 78, connecting channels 84, and aspirator components 96 may be fabricated from stainless-steel with a nominal wall thickness of about 2.7 millimeters; and the valves 94 may be fabricated from brass with a nominal wall thickness of about 2.1 millimeters. It is contemplated that the dispenser of this example may be suitable for high pressure (e.g., 500-600 psi) and/or high temperature (e.g., 250-260° F.) applications.

Hoses may be connected to the primary intake port 86 and the outlet port 88 (e.g., using ¼ inch national pipe taper hose adaptors configured to connect ½ inch hoses) to direct fluid into and away from the dispenser 74, respectively.

The aspirator components 96 may include a tee joint that includes a hose fitting (e.g., hose barb) that serves as a secondary intake port 102. The aspirator components 96 and the valves 94 may each be connected using NPT (national pipe thread) hex joint fittings 98 (e.g., ¼ inch NPT hex joint fittings). Hoses (e.g., ¼ inch hoses) may be connected to the secondary intake ports 102 and inserted into a vessel containing a secondary fluid.

It is contemplated that the dispensers of FIGS. 5 and 7 can be utilized to mix and dispense a wide variety of chemical solutions and/or water. For example, the primary fluid may be water and the secondary fluids may be concentrated chemical solutions that need to be diluted. In another example, the primary fluid and the secondary fluids may both be ready-to-use chemical solutions that need to be mixed together at a predetermined ratio. These chemical solutions and/or water may each be contained in separate vessels located within the interior of vehicle 10 (which may service as the primary or secondary fluid sources 20, 30).

The system 100 can alternatively utilize different types of dispensers 50. For example, the dispenser 50 may utilize dedicated pumps or impellers for drawing liquids into the manifold rather than through aspiration or through an external pump (e.g., pump 24). In another example, the dispenser 50 may be configured to dispense each liquid separately rather than combining them in an outgoing stream.

The suitability of a given liquid dispensing systems/apparatus may be determined based on considerations such as: overall durability, the type of liquids to be mixed (e.g., with consideration given to degree of viscosity, corrosiveness, toxicity, etc.), the number of different liquids to be mixed, and the degree of precision required in the amount of liquid to be drawn by the liquid dispenser 20, among other things.

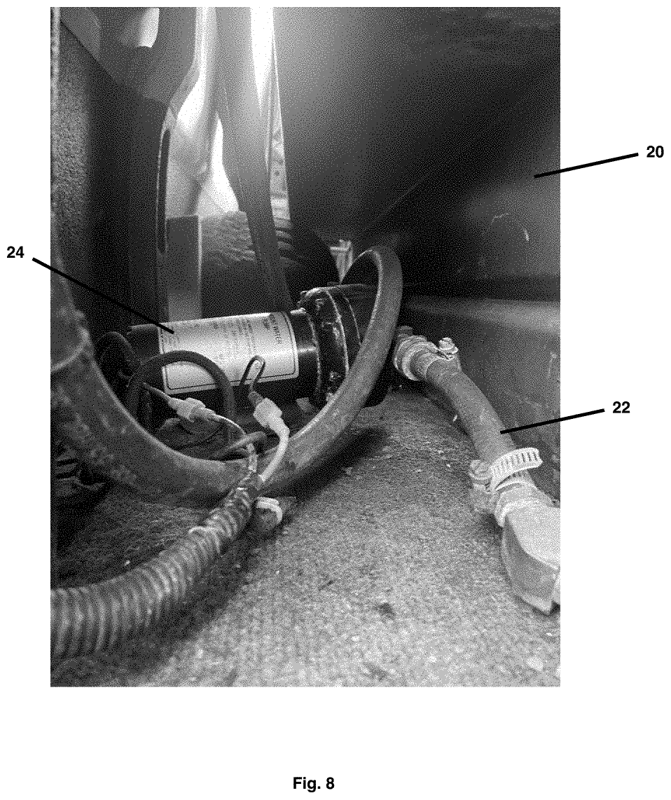

Referring to FIG. 8, the system includes a pump 24 fluidly connected to the dispenser 50 and a primary fluid source 30 (e.g., a water tank or a container of chemical solution) via hose 22. The pump 24 is configured to pressurize primary fluid from the primary fluid source 20 and feed it into the dispenser 50 through an intake port. The primary fluid may then flow through a fluid channel of the dispenser 50 causing the aspiration of a secondary fluid which, in turn, yields an operative fluid. Preferably, pump 24 should be capable of operating within the auxiliary power constraints of most motor vehicles—e.g., 12 volts or less of direct current power. Preferably, pump 24 should be capable of generating a fluid pressure of about 40 to 50 pounds per square inch (PSI), or more preferably about 45 PSI. An example of such a pump includes model no. 5502-2C01 M638JD available from AquaTec of Irving, Calif.

The dispensers of FIGS. 5 and 7 may incorporate orifices 66 (i.e., flow restrictors or orifice restrictors, best shown in FIG. 5) to control the volumetric flow of secondary fluid that gets aspirated when a primary fluid is flowing through dispenser 50. These orifices 66 may be incorporated into the hoses that fluidly connect the dispenser 50 to various primary and/or secondary fluid sources. These orifices 66 may be incorporated proximate (i.e., at or near) the aspirator components of the dispenser 50. These orifices 66 may vary in size and shape. Preferably, the orifices 66 would be circular in shape with a diameter ranging from about 0.020 inches to about 0.035 inches, or even more preferably from about 0.025 inches to about 0.030 inches. With a 45 PSI pump, such orifices will yield an operative fluid at a primary-to-secondary-fluid ratio of about 64-to-1 to about 34-to-1 for secondary fluids with a viscosity of 1 centipoise, 102-to-1 to about 69-to-1 for secondary fluids with a viscosity of 75 centipoise, and 142-to-1 to about 160-to-1 for secondary fluids with a viscosity of 200 centipoise.

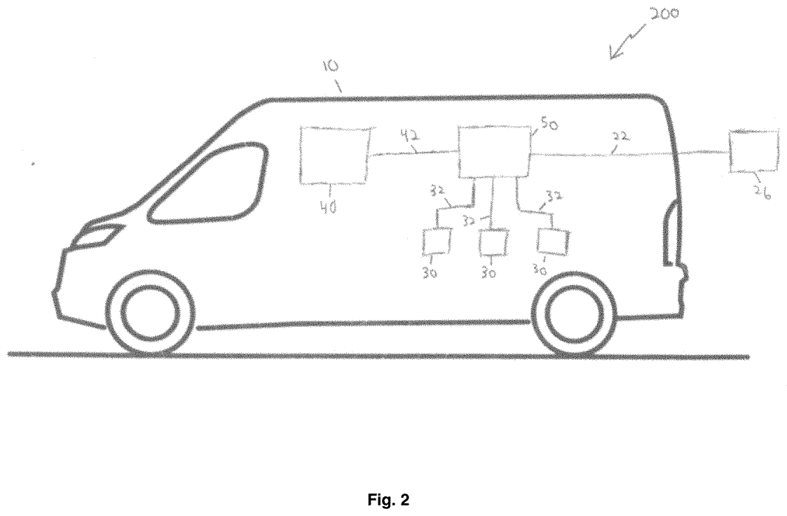

Referring to FIG. 2, the present disclosure provides a second exemplary embodiment of the system 200. This embodiment is similar to the embodiment of FIG. 1 except that instead of receiving pressurized primary fluid from a vessel and a pump, hose 22 may instead be connected to an on-site pressurized source of a primary fluid 26. This can include, for example, a facility water faucet or spigot. Hose 22 can then be fluidly connected to a primary intake port of a dispenser 50 and used to channel pressured primary fluid thereto.

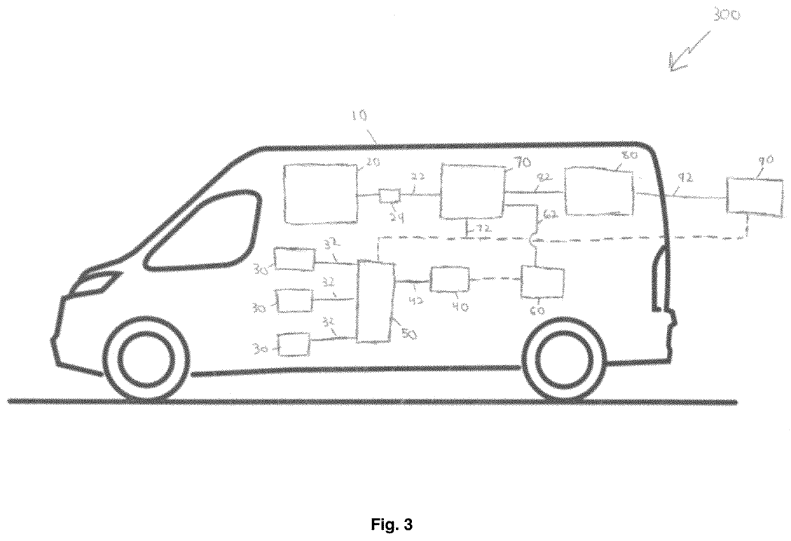

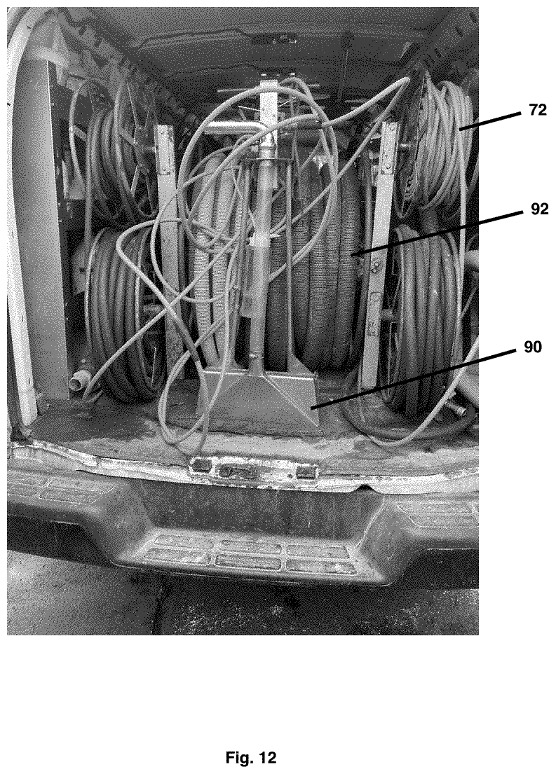

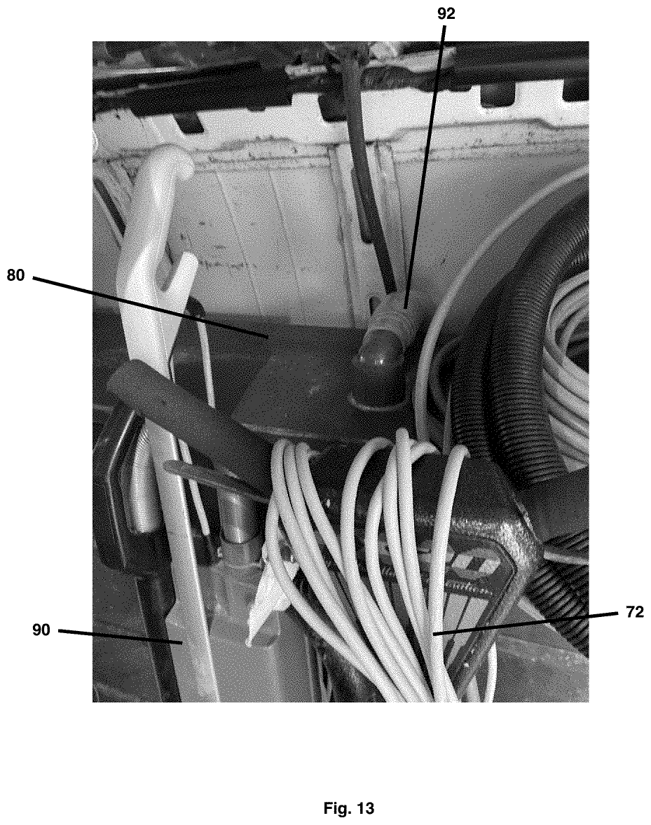

Referring to FIG. 3, the present disclosure provides a third exemplary embodiment of the system 300. This embodiment is configured to received pressurized primary fluid (e.g., water) from a truck mounted heat extraction unit 70 (herein, a “truck mount”). Truck mounts are wet/dry vacuums commonly used in the mobile cleaning industry. They are designed to be mounted in a mobile vehicle (e.g., cargo or utility van) and generate vacuum pressure which gets channeled to an end-tool 90 (e.g., cleaning wand, hand tool, upholstery tool, etc.) hose 92 (shown in FIG. 12). In one or more embodiments, hose 92 may be routed through a waste container 80 fluidly connected to the truck mount (shown in FIG. 13). Some truck mounts, however, also provide for the intake of water and/or cleaning solution and the dispensing of a fluid (i.e., the water and/or cleaning solution) (which gets channeled through a separate hose to the same or a different end-tool). The end-tool 90 may be configured to spray the fluid or otherwise apply this to a surface or object for an intended purpose (e.g., cleaning, fertilizing, deodorizing, etc.). These truck mounts may include pumps for pressuring the fluid and/or heating elements (e.g., heat exchangers) for heating the fluid. Thus, it is contemplated that truck mounts can be incorporated into the system 300 either in addition to, or as an alternative for, a stand-alone pump (e.g., pump 24). Further, it is also contemplated that heating the fluid may be beneficial for improving the mix quality of the operative fluid (e.g., by helping the dispensed liquids mix faster, more completely, or stay mixed longer).

Those skilled in the art will appreciate that truck mounts typically output fluids at relatively high pressure (e.g., 500-600 psi) and temperature (e.g., 250-260° F.). Due to this, it is contemplated that most conventional dispensers would be incompatible with truck mounts since they are not designed to withstand such conditions (a conventional dispenser may only have a maximum temperature limit of around 180° F.). However, the dispenser of FIG. 7 (as described above) is significantly more durable. It is contemplated that the dispenser of FIG. 7 would be compatible with the system 300 of the present embodiment.

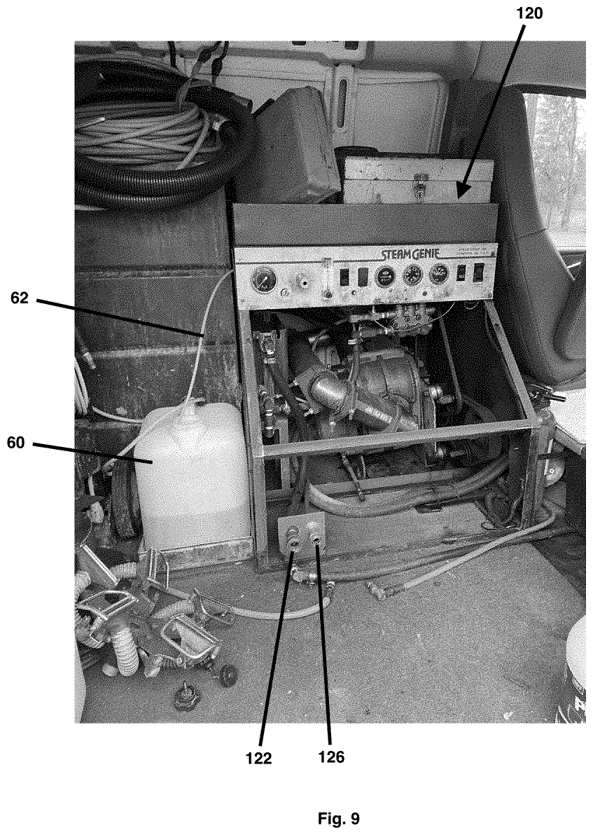

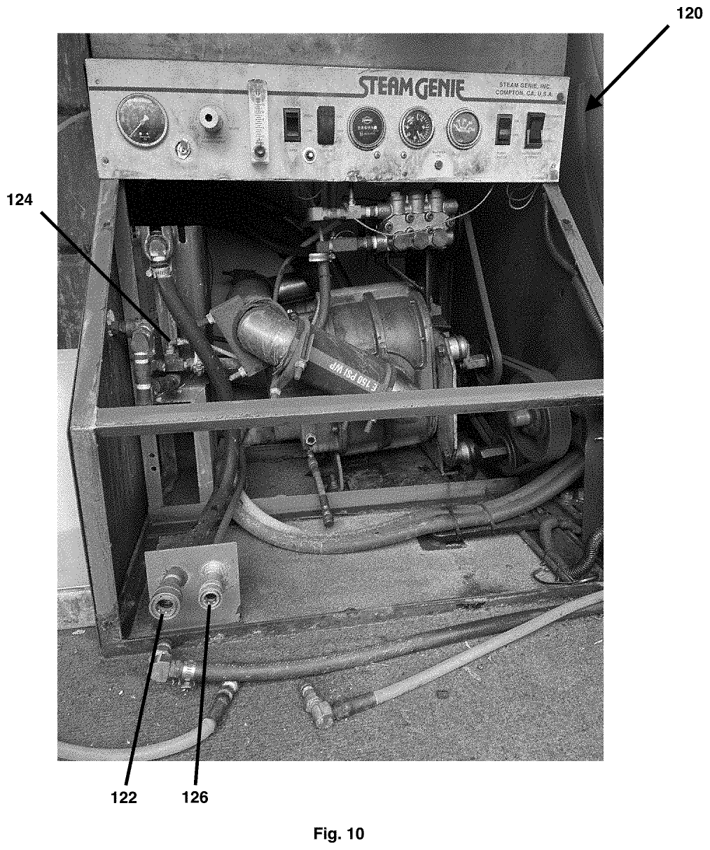

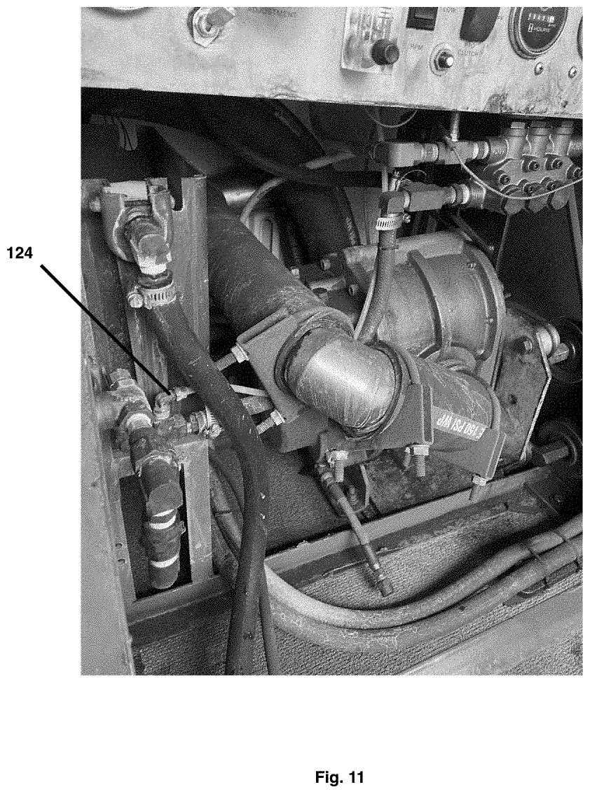

Referring to FIGS. 9-11, the present disclosure provides an exemplary embodiment of a truck mount 120 that can be utilized with the system 300 of FIG. 3. The truck mount 120 includes a water intake port 122, a chemical solution intake port 124 (which is configured to draw chemical solution from container 60 through hose 62, best shown in FIG. 11), a pump, a heating element, and a fluid output port 126. Water intake port 122 can be connected to hose 22 which, in turn, can be inserted into a portable primary fluid source 20 (which may be a water tank but is not limited to such). Primary fluid from the primary fluid source 20 can be pressurized by the truck mount pump, heated by the truck mount heating element, and then channeled out through the fluid output port 126. If desired, a secondary fluid can be poured into the container 60 to introduce the secondary fluid to the outgoing pressurized water stream.

A hose 72 may be utilized to connect fluid output port 130 to the primary intake port of a dispenser 50. Pressurized primary fluid from the truck mount 120 can thus be channeled to the dispenser 50 to enable the functions describe above (e.g., aspiration of various chemical solutions).

Once the dispenser 50 of the system 300 of FIG. 3 yields operative fluid in receiving container 40, that operative fluid may optionally be channeled into container 60. From there, fluid line 72 can be detached from the water intake port of the dispenser 50 and connected to an end-tool 90. Doing so enables the operative fluid to be introduced into the outgoing water steam of the truck mount 120 and thereby channeled to the end tool 90 for in-field use.

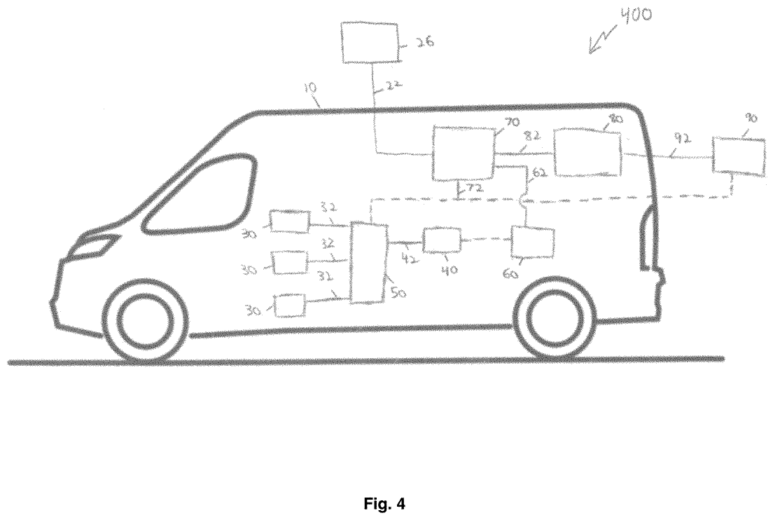

Referring to FIG. 4, the present disclosure provides a fourth exemplary embodiment of the system 400. This embodiment is similar to the system 300 of FIG. 3 except that instead of receiving pressurized primary fluid from portable primary fluid source 20 and a pump 24, hose 22 may instead be connected to an on-site pressurized primary fluid source 26, such as a facility water faucet or spigot. Hose 22 can then be fluidly connected to a water intake port of the truck mount 70 and used to channel primary fluid thereto.

It is contemplated that the systems disclosed herein would find utility in any industry that makes use of mobile and/or on-the-go service vehicles (of any variety). The systems disclosed herein are intended for people (e.g., servicers) who, through the course of their day or through rendition of services, requires that a chemical (of any variety) be mixed with water or a chemical solution to yield an end-use solution or product that is specially formulated for its intended purpose.

The systems disclosed herein may be configured to obtain water and/or chemical solution from a truck mount installed in a vehicle. The truck mount may be capable of producing the proper fluid pressure as well as producing water and/or chemical solution in a range of temperatures (ranging from hot to cold) which may enhance the chemicals' ability. Alternatively, water and/or chemical solution may be obtained from a fresh water source/tank already installed in a vehicle, or from a job site, or from a separate vehicle carrying the water source and/or chemical solution.

It is contemplated that the invention may be ideal for, but not limited to, the professional mobile carpet cleaning industry, the professional mobile power washing industry, the mobile car detailing industry, and/or the professional mobile lawn care industry.

The systems disclosed herein may improve safety by enabling accidents to be handled properly safely, and quickly, which can improve the wellbeing of employees. The systems disclosed herein can yield better results by ensuring the accurate dilution of solutions, thereby resulting in the intended effectiveness for the newly mixed solution, reduced product waste, and reduced cargo weight in service vehicles (thereby leading to less fuel consumption, a smaller chance of vehicular accents, and less wear and tear on engines, brakes, and transmissions). The systems disclosed herein can also be better for the environment since shipping companies will not have to haul ready-to-sue solutions across the interstates (which reduces emissions, fuel consumption, and traffic congestion). The systems disclosed herein can also yield cost savings by reducing the amount of labor required to mix solutions, and by allowing companies to purchase concentrated product rather than pre-diluted solutions/chemicals.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A mobile system for mixing and dispensing, the system comprising:
a vehicle with an interior;
a first vessel for containing a quantity of a first liquid, wherein the first vessel is located within the interior of the vehicle;
a second vessel for containing a quantity of a second liquid, wherein the second vessel is located within the interior of the vehicle;
a dispenser for dispensing quantities of the first liquid and the second liquid, wherein:
the dispenser is located within the interior of the vehicle;
the dispenser comprises a first intake port, a second intake port, and a fluid outlet port;
the first intake port is fluidly connected to the first vessel and the second intake port is fluidly connected to the second vessel;
the dispenser further comprises a fluid channel that enables the first liquid to flow from the first intake port to the fluid outlet port;
the dispenser further comprises an aspirator component incorporated into the fluid channel that is fluidly connected to the second intake port;
the aspirator component enables aspiration of the second liquid into the fluid channel when the first liquid is flowing through the fluid channel, thereby yielding an operative fluid in the fluid channel;
a pump fluidly connected to the first vessel and the dispenser, wherein the pump is configured to transfer the first liquid from the first vessel to the dispenser, and wherein the pump is located within the interior of the vehicle.

2. The system of claim 1, wherein the first liquid is water and the first vessel is a water tank.

3. The system of claim 2, wherein the water tank is a 100-gallon water tank.

4. The system of claim 1, wherein the second liquid is a concentrated chemical solution and the second vessel is a container for the concentrated chemical solution.

5. The system of claim 1, wherein the pump is a 12-volt direct current pump.

6. The system of claim 5, wherein the pump is configured to generate a fluid pressure of between 40 and 50 pounds per square inch.

7. The system of claim 6, wherein the aspirator component comprises an orifice component that controls the rate at which second liquid is aspirated into the fluid channel.

8. The system of claim 7, wherein the orifice component defines a circular orifice that is between 0.025 inches and 0.030 inches in diameter.

9. A mobile system for mixing and dispensing, the system comprising:
a vehicle with an interior;
a water tank for containing a quantity of water, wherein the water tank is located within the interior of the vehicle;
a container for containing a quantity of chemical solution, wherein the container is located within the interior of the vehicle;
a dispenser for dispensing an operative fluid, wherein:
the dispenser is located within the interior of the vehicle;
the dispenser comprises a first manifold, a second manifold, and a fluid channel fluidly connecting the first and second manifolds;
the first manifold comprises a water intake port;
the second manifold comprises an operative fluid outlet port;
the dispenser further comprises an aspirator component incorporated into the fluid channel that is fluidly connected to the container;
the aspirator component is configured to aspirate concentrated chemical solution into the fluid channel when water is flowing through the fluid channel, thereby yielding an operative fluid in the fluid channel;
a heat extraction truck mount unit located within the interior of the vehicle, comprising:
a water intake port fluidly connected to the water tank;
a fluid outlet port;
a fluid channel that enables the water to flow from the water intake port to the fluid outlet;
a pump for transferring the water from the water intake port to the fluid outlet;
a heating element for heating the water as it is transferred from the water intake port to the fluid outlet port.

10. The system of claim 9, wherein the truck mount is configured to output water at a fluid pressure of at least 500 pounds per square inch. 11, The system of claim 10, wherein the truck mount is configured to output water at a temperature of at least 250° F.

12. The system of claim 10, wherein at least one of the first manifold and the second manifold of the dispenser comprises a stainless-steel material composition.

13. The system of claim 10, wherein at least one of the first manifold, the second manifold, and the fluid channel of the dispenser comprises a nominal wall thickness of 2.5 millimeters or greater.

14. The system of claim 9, wherein the dispenser further comprises an electronically-actuated solenoid valve incorporated into the fluid channel that is configured to open or close the fluid channel.

15. A mobile system for mixing and dispensing, the system comprising:
a vehicle with an interior;
a container of liquid chemical solution located within the interior of the vehicle;
a dispenser for dispensing quantities of a first liquid and a second liquid, wherein:
the dispenser is located within the interior of the vehicle;
the dispenser comprises a first intake port, a second intake port, and a fluid outlet port;
the first intake port is fluidly connectable to a water source;
the second intake port is fluidly connected to the container of chemical solution;
the dispenser further comprises a fluid channel that enables water to flow from the first intake port to the fluid outlet port;
the dispenser further comprises an aspirator component incorporated into the fluid channel that is fluidly connected to the second intake port;
the aspirator component enables aspiration of the second liquid into the fluid channel when the first liquid is flowing through the fluid channel, thereby yielding an operative fluid in the fluid channel;
a pump fluidly connected to the water source and the dispenser, wherein the pump is configured to transfer water from the water source to the dispenser, and wherein the pump is located within the interior of the vehicle.
